(19) United States
(12) Patent Application Publication
(10) Pub. No.: US 2016/0282138 A1
(43) Pub. Date: Sep. 29, 2016

(54) SURGE-PROTECTED SENSOR

(71) Applicant: HIRSCHMANN AUTOMATION AND CONTROL GMBH, Neckartenzlingen (DE)

(72) Inventor: Zivorad GOLUBOVIC, Karlsruhe (DE)

(21) Appl. No.: 15/031,013

(22) PCT Filed: Dec. 9, 2014
(86) PCT No.: PCT/EP2014/076963

§ 371 Date: May 6, 2016

(30) Foreign Application Priority Data
Dec. 13, 2013 (DE) 10 2013 020 583.2

(51) Int. Cl. G01D 3/08; H02H 9/04

(52) U.S. Cl. CPC G01D 3/08; H02H 9/04

(57) ABSTRACT

Disclosed is a surge-protected sensor assembly (1) comprising at least one sensor (2) for detecting an operating parameter, electronic components (3 to 7) and an input (8) for a power supply (9), characterized in that an electronic component (3) is connected in series to the input (8) and is a PPTC component.

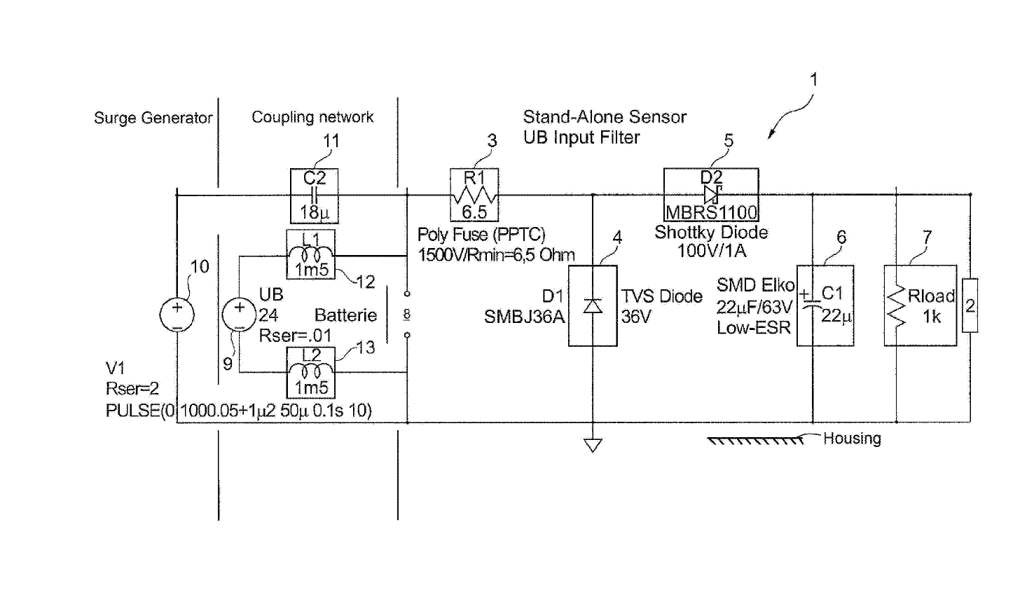

The invention relates to a surge-protected sensor assembly comprising at least one sensor for detecting an operating parameter as well as electronic components and an input for a power supply in accordance with the features of the preamble of claim 1.

Such sensor assemblies also as “intelligent” or “active” sensor assemblies, are known. Such a sensor assembly has at least one sensor with which an operating parameter of a system, a plant, a vehicle or the like is to be detected. The respective sensor is configured depending on the operating parameter to be detected.

Here, these preferably are contact-free operating sensors with which operating parameters such as for example pressure, temperature, rotation speed, force and the like (non-concluding enumeration) are detected. On detection of the operating parameter, the sensor outputs a signal, or else it is supplied with a power supply so that it is able to detect the operating parameter and to produce an output signal. In both cases, in the known sensor assemblies, the output signal of the at least one sensor is processed by downstream electronic components, for example enhanced, filtered, checked for plausibility or the like. Thus, the whole sensor assembly provides to another downstream electronic control unit an output signal that can there be further processed, saved, displayed or the like.

Summarizing, such a sensor assembly (also referred to as sensor unit) is therefore most commonly to be seen as a small and inexpensive component in a complete sensor device further comprising a housing, a power supply, connections and the like. The main requirements for the sensor assembly surface, which currently is not larger than a few square centimeters, are installation space, required space, production costs, simplicity, simultaneously having a high sensitivity in detecting the operating parameter.

In addition, one of the main requirements for such a sensor assembly is that it works flawlessly under any conditions. Under raw environmental conditions in which temperature, humidity and the like often alternate, electric interference pulses may time and again influence the sensor assembly and thus the sensor itself. Thus, there is a risk that the sensor assembly supplies inaccurate starting values or, in the worst case, is temporarily rendered inoperative by such an interference pulse or even completely destroyed.

Thus, it is the object of the invention to improve a sensor assembly that is effectively protected against electric interference pulses influencing the sensor assembly from the exterior.

This object is achieved by the features of claim 1.

According to the present invention, an electronic component is connected in series to the input of the sensor assembly and is a PPTC component.

This has the advantage that electric interference pulses from the electronic series-connected component to the input are absorbed and blocked. The PPTC component (PPTC: Polymeric Positive Temperature Coefficient) is an electronic protection module combining the function of an excess temperature protection with those of a switch. The PPTC component is a temperature-dependant module with low resistance such that, due to these characteristics, it can advantageously be connected in series to the input in order that the transmitted power supply voltages and/or the transmitted output signals are not disturbed, falsified or blocked when the sensor assembly is operated in the normal state. The PPTC component has the advantageous characteristic that its resistance increases rapidly at a certain temperature and thereby restricts the power. In this function, the PPTC component is locked and remains in that state even if the temperature decreases. A reset only sets in when the supply voltage has been switched off and on again. The PPTC component thus has the advantage that, due to these characteristics, it can be employed as a resettable protection against interference pulses. Another advantage of the component can be seen in that it also serves as a thermal protection and also as an overcurrent protection. In sensor assemblies, it can be configured for various voltages and furthermore has the advantage that, when an interference pulse has influenced the sensor assembly, it functions like a resettable protection in this event of damage and, unlike a conventional protection, particularly a fuse, does not need to be replaced. This advantageously increases operator convenience during the service life of such a sensor assembly.

PPTC components are also referred to as polymer PTCs.

In a further improvement of the invention, the power consumption of the sensor assembly is less or equal to 100 mA, preferably less or equal to 50 mA.

When a sensor assembly is to be considered as a stand-alone system component, the sensor assembly or sensor also has to pass the EMC test according to EN 61000-4-5 level 1, i.e. withstand an interference pulse such as from a lightning strike or a surge. The test is a test having an interference voltage of Vgen=500 V/Rgen=2 Ohm. Level 2 even requires Vgen=1000 V/Rgen=2 Ohm. (Vgen: voltage of the interference-pulse generator, Rgen: source resistance of the interference-pulse generator). In order to absorb the interference impulse's energy, as is known, unacceptably large capacitors, particularly e-caps (electrolytic capacitor) are needed up to date for a sensor assembly. Conversely, in order to avoid the interference pulse's energy (for example via a series resistor), a series element is needed to reduce the power. This element has to withstand the voltage drop and the resulting power loss during the interference pulse. When the sensor assembly's power consumption is less/equal to 50 milliampere 50 mA), an inventive PTC Resettable Fuse (PPTC) can be employed in combination with other suitable components. It is thus even possible to pass the level 2 test. The PPTC always ensures a minimal resistance of, for example, Rpptc_min=6.5 Ohm up to an interference pulse having 1500V, thereby restricting the maximum power of the whole sensor assembly to an acceptable value (Imax=Vgen/Rpptc_min). A diode, particularly a TVS diode, and a capacitor, particularly a SMD e-cap, are capable of easily absorbing the remaining energy of the interference pulse at the sensor assembly's input. At the same time, the resulting input voltage for further needed DCDC controller is less than 50V that can easily be absorbed.

In a further improvement of the invention, the sensor assembly has means for carrying out a reset. As described above, the PPTC component is reset by switching off the supply voltage and switching it on again. For this, means such as switches, momentary switches or the like are advantageously envisaged with which the power-supply voltage can be switched off and switched on again can be realized. A sensor assembly is thereby provided that is very operator friendly.

For the realization of such a sensor assembly, it is envisaged in an improvement of the invention that the at least one sensor as well as the corresponding electronic components, optionally also the means for carrying out a reset, are mounted on a common circuit board. As a result, the inventive sensor assembly can be realized according to requirements on a small surface (preferably less than a few square centimeters). If necessary, the sensor assembly's power supply, such as a battery, a storage battery, a photovoltaics element or the like, can also be mounted on the circuit board.

In a further improvement of the present invention, the sensor assembly has a housing within which the at least one sensor, the electronic components and optionally other elements of the sensor assemblies are accommodated. The housing can be a one-piece or multipart housing in which the individual components of the sensor assembly are arranged. Alternatively, it is conceivable that a sensor assembly with its at least one sensor, the electronic components, the circuit board and optionally other means is potted in plastic such that it is effectively protected against external influences such as contamination, particularly with metallic particles, humidity and mechanical influences.

In a further improvement of the present invention, an application of the inventive sensor assembly for detecting operating parameters from machines, particularly stationary or mobile construction machines or cranes, is advantageously provided. In such machines, it is already very important during normal operation that their operating parameters are reliably and constantly flawlessly detected as the safety-related operation of such machines essentially depends thereupon. For this reason, sensor assemblies or the sensors thereof are provided redundantly. With the inventive PPTC component, the sensor assembly for such machines is effectively protected against external electric interference pulses (advantageously against short pulses, particularly in the range of microseconds such as in the range of 50 microseconds) that during the machines' operation may indeed occur frequently. In a normal case, i.e. when there is no interference from the exterior, particularly no interference signal or no interference pulse, the PPTC component is not effective. It is only in the case of an incident, i.e. when an interference pulse influences the sensor assembly from the exterior, that the PPTC component responds as a stable high voltage resistor, thereby effectively reducing the voltages or currents that influence the PPTC component to a level at which the sensor assembly does not suffer any damage. This is achieved by the PPTC component that does not take up much space (compared to other known protection elements). The resettability of the component further has the advantage that, when a different interference signal (not the interference pulse described above) has “quasi switched off” the sensor assembly, a reset and restart can be quick and straightforward such that work with the machines only has to be interrupted for a short while.

The configuration of an exemplary inventive sensor assembly is shown in the only figure.

A sensor assembly 1 has, as far as represented in detail, a sensor 2, although more than one sensor 2 can also be provided. Furthermore, electronic components 3 to 7 are provided. Electronic component 3 is the inventive PPTC series-connected component, electronic component 4 is a diode, electronic component 5 is also a diode, particularly a Schottky diode, electronic component 6 is a capacitor, particularly an electrolyte capacitor, and electronic component 7 is a load resistor.

The sensor assembly 1 has an input 8, particularly two input terminals or the like. The sensor assembly 1 is supplied with power via the input 8. The power comes from a power supply 9 that is either externally coupled to the sensor assembly 1 or also integrated within the sensor assembly 1 itself.

For simulating an electric interference pulse influencing the sensor assembly 1 from the exterior, an interference-pulse generator 10 is temporarily connected to the input 8 of the sensor assembly 1. The interference-pulse generator 10 feeds an interference pulse into the input 8 depending on pre-determinable testing conditions. As, according to the invention, the component 3 is connected in series and configured as a PPTC component, the power of this interference pulse is absorbed by the component thus preventing the interference pulse from negatively influencing the remaining components of the sensor assembly 1, particularly the sensor 2. For simulating such an interference pulse, the interference-pulse generator 10 is connected to the input 8 via an electronic component such as the capacitor 11. Depending on the configuration of the power supply 9, it can be directly connected to the input 8. In this embodiment, the power supply 9 is connected to the input 8 via two further electronic components 12 and 13 connected in series (here coils).

This circuit shown in the drawing at the same time also ensures other requirements of a sensor input filter, namely such as:
low serial voltage drop
polarity protection
UBmax in the industrial and automotive area
Low-pass filter

### LIST OF REFERENCE NUMBERS

1 Sensor assembly
2 Sensor
3 Electronic component
4 Electronic component
5 Electronic component
6 Electronic component
7 Electronic component
8 Input
9 Power supply
10 Interference-pulse generator
11 Electronic component
12 Electronic component
13 Electronic component

1. A sensor assembly with surge protection, the assembly comprising:
at least one sensor for detecting an operating parameter;
electronic components;
a power supply;
an input for the power supply; and
an electronic PPTC component connected in series to the input.

2. The sensor assembly according to claim 1, wherein power consumption of the sensor assembly is ≦100 milliampere.

3. The sensor assembly according to claim 1, wherein the sensor assembly has means for carrying out a reset.

4. The sensor assembly according to claim 1, further comprising:
a circuit board on which are mounted the at least one sensor as well as the electronic components.

5. The sensor assembly according to claim 1, further comprising:
a housing holding the sensor assembly.

6. An application of a sensor assembly according to claim 1 for detecting operating parameters of stationary or mobile construction machines or cranes.
